(19) United States
(12) Patent Application Publication
(10) Pub. No.: US 2012/0013721 A1
(43) Pub. Date: Jan. 19, 2012

(54) AUDIO/VIDEO REPRODUCTION SYSTEM, HEARING AID, AND AUDIO/VIDEO PROCESSING DEVICE

(75) Inventors: Takatoshi NISHIO, Osaka (JP); Kenjl Nabara, Kyoto (JP); Toshihiro Yamaoka, Osaka (JP)

(73) Assignee: PANASONIC CORPORATION, Osaka (JP)

(21) Appl. No.: 13/243,069

(22) Filed: Sep. 23, 2011

Related U.S. Application Data
(63) Continuation of application No. PCT/JP2010/000579, filed on Feb. 1, 2010.

(30) Foreign Application Priority Data
Mar. 24, 2009 (JP) 2009-072327

(51) Int. Cl. H04N 7/18

(52) U.S. Cl. 348/61

(57) ABSTRACT

An audio/video processing device includes a signal processing circuit and a video reproduction circuit. The signal processing circuit supplies an audio signal to a hearing aid, and delays a video signal from the audio signal by a delay time of the hearing aid and supplies the delayed video signal to a video reproduction circuit. The hearing aid performs a hearing aid process on the audio signal supplied from the signal processing circuit to reproduce a sound. The video reproduction circuit reproduces an image from the video signal supplied from the signal processing circuit.

### CROSS-REFERENCE TO RELATED APPLICATIONS

This is a continuation of PCT International Application PCT/JP2010/000579 filed on Feb. 1, 2010, which claims priority to Japanese Patent Application No. 2009-072327 filed on Mar. 24, 2009. The disclosures of these applications including the specifications, the drawings, and the claims are hereby incorporated by reference in their entirety.

### BACKGROUND

The technology disclosed herein relates to audio/video reproduction systems which use a hearing aid process for aiding the auditory function, and hearing aids and audio/video processing devices for use in the audio/video reproduction systems.

Conventionally, a signal processing technique (hearing aid process technique) of aiding the auditory function is used not only for hearing aids, but also for devices which additionally output sounds (audio/video reproduction systems), such as televisions etc. For example, Japanese Patent Publication No. H05-252594 describes a television which includes a digital audio processing device which performs a process of dealing with a frequency characteristic of an audio signal and a process of changing the time length of an audio signal. In this television, a receiver separates a broadcast radio wave into a video signal and an audio signal, performs various processes on the video signal, and supplies the resultant video signal to a display. On the other hand, the digital audio processing device performs the hearing aid process on the audio signal, and supplies the resultant audio signal to a loudspeaker. By processing the audio signal in such a manner, a hearing-impaired user can easily hear sound.

### SUMMARY

However, in conventional audio/video reproduction systems, the audio signal is delayed from the video signal due to the hearing aid process, and therefore, sounds and images cannot be synchronized with each other in the user's brain, which the sounds and images finally reach. Therefore, a time difference occurs between the user's sound recognition and image recognition. In particular, if an audio signal is transmitted to the digital audio processing device by wireless communication, the time difference is likely to be significant.

The time difference may be reduced by decreasing the delay time in the digital audio processing device. In this case, however, the time required for the hearing aid process is limited, and therefore, it is difficult to increase the accuracy of the hearing aid process (e.g., improve the sound quality) and enhance the performance of the digital audio processing device.

According to one aspect of the present disclosure, a system for reproducing a sound and an image includes a hearing aid, and an audio/video processing device including a signal processing circuit and a video reproduction circuit. The signal processing circuit supplies an audio signal to the hearing aid, and delays a video signal from the audio signal by a delay time of the hearing aid and supplies the delayed video signal to the video reproduction circuit. The hearing aid performs a hearing aid process on the audio signal supplied from the signal processing circuit to reproduce a sound. The video reproduction circuit reproduces an image from the video signal supplied from the signal processing circuit. In the audio/video reproduction system, the time difference between sound recognition and image recognition of the hearing aid user can be reduced. As a result, uncomfortable viewing and hearing can be reduced for the hearing aid user. The accuracy of the hearing aid process can be improved and the number of functions of the hearing aid can be increased irrespective of the delay time in the hearing aid.

Note that the hearing aid may transmit delay information indicating a hearing aid processing time required for the hearing aid process, and the signal processing circuit may set the delay time based on the delay information. With this configuration, the signal processing circuit can delay the video signal by a delay time corresponding to the hearing aid processing time (a processing time required for the hearing aid to perform a hearing aid process). As a result, the hearing aid processing time can be canceled out by the delay time of the video signal.

The hearing aid may transmit delay information indicating the sum of a hearing aid processing time required for the hearing aid process and a transfer processing time required for transfer of the audio signal from the audio/video processing device to the hearing aid. The signal processing circuit may set the delay time based on the delay information. With this configuration, not only the hearing aid processing time but also the transfer processing time can be canceled out by the delay time of the video signal.

The signal processing circuit may output an identification signal when the signal processing circuit is ready to supply the audio signal, and the hearing aid, when detecting the identification signal, may perform a predetermined hearing aid process on the audio signal. With this configuration, when the signal processing circuit is ready to supply an audio signal, the hearing aid can be automatically set to an appropriate operating mode. For example, when the hearing aid user turns on the audio/video processing device, the user can enjoy viewing and hearing with an appropriate volume and quality of sound.

According to another aspect of the present disclosure, a system for reproducing a sound and an image includes a plurality of hearing aids, and an audio/video processing device including a signal processing circuit and a video reproduction circuit. The signal processing circuit supplies an audio signal to each of the plurality of hearing aids, and delays a video signal from the audio signal by a delay time obtained based on processing times of the plurality of hearing aids and supplies the delayed video signal to the video reproduction circuit. Each of the plurality of hearing aids performs a hearing aid process on the audio signal supplied from the signal processing circuit to reproduce a sound. The video reproduction circuit reproduces an image from the video signal supplied from the signal processing circuit. In the audio/video reproduction system, the time difference between sound recognition and image recognition can be uniformly reduced for a plurality of hearing aid users. As a result, uncomfortable viewing and hearing can be reduced for each hearing aid user.

Note that the delay time may be changed by an external control. With this configuration, the hearing aid user can appropriately adjust the delay time based on a state of the user's auditory function, such as the level of difficulty in hearing, etc.

According to still another aspect of the present disclosure, a hearing aid for processing an audio signal supplied from an audio/video processing device, includes an information transmission circuit including a delay information transmitter configured to transmit delay information indicating a processing time of the hearing aid to the audio/video processing device, and a hearing aid body including a hearing aid processor configured to perform a hearing aid process on the audio signal supplied from the audio/video processing device and an audio reproducer configured to reproduce a sound from the audio signal processed by the hearing aid processor. The audio/video processing device includes a signal processing circuit and a video reproduction circuit. The signal processing circuit supplies the audio signal to the hearing aid, and delays a video signal from the audio signal by a delay time corresponding to the processing time indicated by the delay information transmitted from the delay information transmitter, and supplies the delayed video signal to the video reproduction circuit. The video reproduction circuit reproduces an image from the video signal supplied from the signal processing circuit. In the hearing aid, the time difference between sound recognition and image recognition of the hearing aid user can be reduced, and uncomfortable viewing and hearing can be reduced for the hearing aid user. The accuracy of the hearing aid process can be improved and the number of functions of the hearing aid can be increased irrespective of the delay time in the hearing aid.

According to even still another aspect of the present disclosure, a device for supplying an audio signal to a hearing aid and reproducing an image, includes a signal processing circuit and a video reproduction circuit. The signal processing circuit supplies an audio signal to the hearing aid, and delays a video signal from the audio signal by a delay time of the hearing aid and supplies the delayed video signal to the video reproduction circuit. The video reproduction circuit reproduces an image from the video signal supplied from the signal processing circuit. In the audio/video processing device, the time difference between sound recognition and image recognition of the hearing aid user can be reduced, and uncomfortable viewing and hearing can be reduced for the hearing aid user. The accuracy of the hearing aid process can be improved and the number of functions of the hearing aid can be increased irrespective of the delay time in the hearing aid.

### BRIEF DESCRIPTION OF THE DRAWINGS

FIG. 1 is a diagram showing an example configuration of an audio/video reproduction system according to a first embodiment.

FIG. 2 is a diagram for describing a variation of the audio/video reproduction system of FIG. 1.

FIG. 3 is a diagram showing an example configuration of an audio/video reproduction system according to a second embodiment.

### DETAILED DESCRIPTION

Embodiments of the present disclosure will be described in detail hereinafter with reference to the accompanying drawings. In the drawings, the same or similar parts are identified by the same reference characters and the description thereof will not be repeated. In the description which follows, a hearing aid is not limited to those approved as medical devices, and may be those not approved as medical devices (e.g., devices having a hearing aid function, such as an “audio amplifier,” an “assistive listening device,” etc.).

### First Embodiment

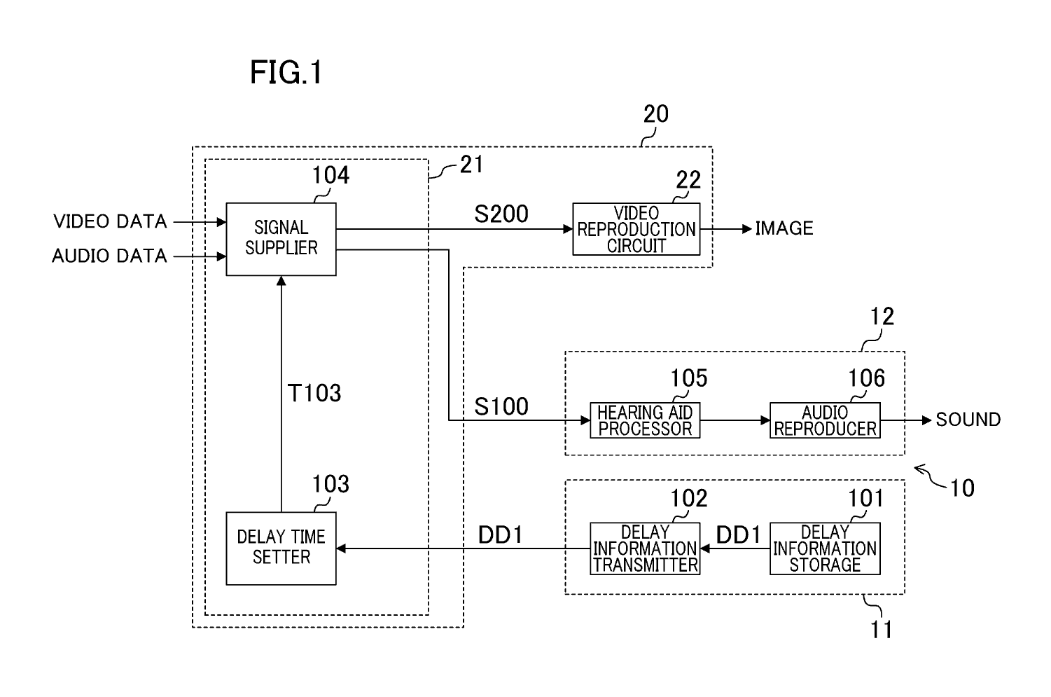

FIG. 1 shows an example configuration of an audio/video reproduction system according to a first embodiment. This system reproduces sounds and images from audio data and video data. The system includes a hearing aid 10 including an information transmission circuit 11 and a hearing aid body 12, and an audio/video processing device 20 (e.g., a television, a doorphone, an automotive navigation system, etc.) including a signal processing circuit 21 and a video reproduction circuit 22. The information transmission circuit 11 transmits, to the audio/video processing device 20, delay information DD1 indicating a processing time corresponding to the hearing aid 10. The signal processing circuit 21 sets a delay time T103 corresponding to the hearing aid 10 based on the delay information DD1, and supplies an audio signal S100 to the hearing aid 10, and delays a video signal S200 by the delay time T103 and supplies the delayed video signal S200 to the video reproduction circuit 22. The video reproduction circuit 22 reproduces an image from the video signal S200. The hearing aid body 12 performs a hearing aid process (an audio process for aiding the auditory function) on the audio signal S100 to reproduce a sound. Note that the information transmission circuit 11 may be separated from the hearing aid body 12 (the information transmission circuit 11 may be, for example, a remote controller). In this case, the information transmission circuit 11 may further include a hearing aid process controller which remotely operates the hearing aid process of the hearing aid body 12 based on a setting which is manually provided by a hearing aid user (a user who uses the hearing aid body 12). The information transmission circuit 11 may be integrated with the hearing aid body 12 to form the hearing aid 10. In this case, the hearing aid 10 may be controlled by a remote controller including the hearing aid process controller. The signal processing circuit 21 may be separated from the video reproduction circuit 22, or may be integrated with the video reproduction circuit 22 to form the audio/video processing device 20.

The information transmission circuit 11 includes a delay information storage 101 and a delay information transmitter 102. The signal processing circuit 21 includes a delay time setter 103 and a signal supplier 104. Note that the signal processing circuit 21 may include separate modules: a signal processing module including the signal supplier 104; and a communication module including the delay time setter 103. The hearing aid body 12 includes a hearing aid processor 105 and an audio reproducer 106. The delay information storage 101 stores the delay information DD1. For example, the delay information DD1 indicates a hearing aid processing time (a time required for the hearing aid body 12 to perform a hearing aid process on the audio signal S100). The delay information transmitter 102 transmits the delay information DD1 stored in the delay information storage 101. The delay time setter 103 receives the delay information DD1 from the delay information transmitter 102, and based on the delay information DD1, sets the delay time T103. For example, the delay time setter 103 sets the delay time T103 to the hearing aid processing time indicated by the delay information DD1. The signal supplier 104 decodes audio data and video data to generate the audio signal S100 and the video signal S200, respectively. The signal supplier 104 also supplies the audio signal S100 to the hearing aid 10, and delays the video signal S200 by the delay time T103 and supplies the delayed video signal S200 to the video reproduction circuit 22. For example, the signal supplier 104 does not supply, but accumulates, the video signal S200 until the delay time T103 has elapsed since the setting of the delay time T103, and after the lapse of the delay time T103, starts supplying the video signal S200. Note that an image (the output of the video reproduction circuit 22) may be fixed (e.g., the same image is repeatedly displayed) until the delay time T103 has elapsed since the setting of the delay time T103. The hearing aid processor 105 performs a hearing aid process on the audio signal S100. The audio reproducer 106 reproduces a sound from the audio signal processed by the hearing aid processor 105.

As described above, by delaying the video signal S200 by the delay time T103 corresponding to the hearing aid 10, the time difference between sound recognition and image recognition of the hearing aid user can be reduced. As a result, uncomfortable viewing and hearing can be reduced for the hearing aid user. For example, by causing the delay time (hearing aid processing time) in the hearing aid 10 and the delay time (the delay time T103) in the video signal S200 to cancel each other out, a sound and an image can be synchronized with each other in the user's brain, which the sound and the image finally reach, whereby uncomfortable viewing and hearing can be reduced, so that the hearing aid user can enjoy viewing and hearing.

Also, by setting the delay time T103 based on the hearing aid processing time, the accuracy of the hearing aid process can be improved (e.g., an improvement in sound quality) and the number of functions of the hearing aid 10 can be increased (e.g., various sound field control functions employed by a DVD player etc. can be added) irrespective of the delay time in the hearing aid. Thus, the appeal of the hearing aid can be expected to increase significantly.

Note that the signal supplier 104 may be switched between an asynchronous supply mode in which the video signal S200 is delayed by the delay time T103 before being supplied as described above and a synchronous mode in which the audio signal S100 and the video signal S200 are supplied in synchronous with each other, depending on the presence or absence of the setting of the delay time T103.

[Delay Information]

The processing time indicated by the delay information DD1 can be calculated based on the details of the process performed by the hearing aid body 12. The delay information DD1 may indicate a processing time other than the hearing aid processing time. For example, the delay information DD1 may indicate the sum of the hearing aid processing time and a transfer processing time (a time required to transmit the audio signal S100 from the signal processing circuit 21 to the hearing aid body 12). The transfer processing time may include a time required to perform a communication protocol for wireless communication (e.g., Bluetooth). For example, the transfer processing time may be the sum of a time required for the signal processing circuit 21 to perform a transmission process on the audio signal S100, a time required for the audio signal S100 to reach the hearing aid body 12 after being transmitted from the signal processing circuit 21, and a time required for the hearing aid processor 105 to perform a receiving process on the audio signal S100. With this configuration, not only the hearing aid processing time but also the transfer processing time can be canceled out by the delay time of the video signal S200. Note that the delay information DD1 may include information other than processing times. For example, the audio/video processing device 20 may be configured so that if the delay information DD1 includes a manufacturer name or a product number, the delay time can be determined based on the manufacturer name or the product number included in the delay information DD1.

[Delay Time]

The delay information transmitter 102 may change the processing time indicated by the delay information DD1 based on an external control (e.g., the processing time may be manually set by the hearing aid user, etc.) before transmitting the delay information DD1. For example, the delay information transmitter 102 may increase and decrease the processing time indicated by the delay information DD1 based on an external control, or may replace the processing time indicated by the delay information DD1 with a processing time set by an external control. Similarly, the delay time setter 103 may change the delay time T103 based on an external control. For example, the delay time setter 103 may increase and decrease the delay time T103 based on an external control, or may output a delay time set by an external control as the delay time T103. With this configuration, the delay time T103 (a delay time of the video signal S200 from the audio signal S100) can be arbitrarily adjusted. As a result, the hearing aid user can appropriately adjust the delay time T103 based on a state of the user's auditory function, such as the level of difficulty in hearing, etc. Note that the delay time T103 may be shorter than the processing time (the processing time corresponding to the hearing aid) indicated by the delay information DD1.

The delay time T103 may be represented in time units, such as seconds etc., or in other units. This also applies to the processing time indicated by the delay information DD1. For example, the delay time T103 may be represented in frames of the video signal S200. This representation allows the video signal S200 to be delayed in a frame-by-frame basis, whereby an image can be easily fixed. Alternatively, the delay time T103 may be represented by the number of reference values indicating timing of reproducing an image (e.g., the system clock reference (SCR) value defined in the MPEG standard etc.). For example, when the signal supplier 104 processes data in conformity with the MPEG standard, the signal supplier 104 processes audio data and video data based on the SCR value. Therefore, by representing the delay time T103 using the number of the SCR values, a delay time of the video signal S200 from the audio signal S100 can be accurately set.

(Variation of First Embodiment)

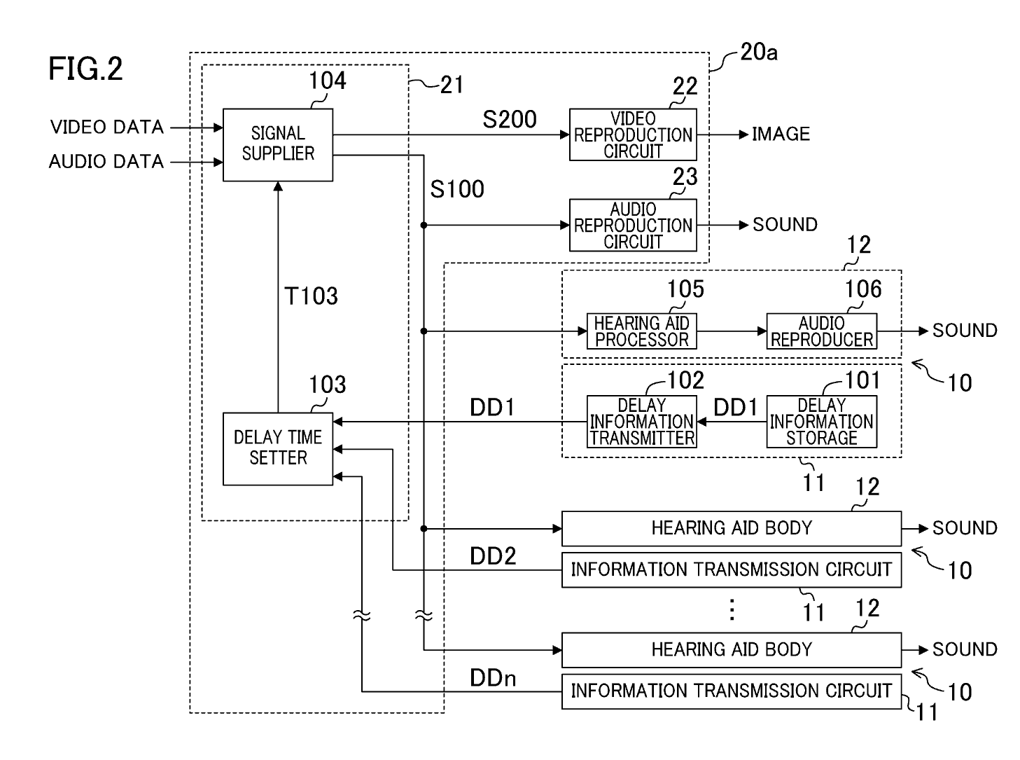

As shown in FIG. 2, the audio/video processing device may transmit the audio signal S100 to a plurality of hearing aids. An audio/video reproduction system shown in FIG. 2 includes n (n is an integer of two or more) hearing aids 10, 10, . . . , and 10, and an audio/video processing device 20a which deals with the n hearing aids 10, 10, . . . , and 10. N information transmission circuits 11, 11, . . . , and 11 transmit delay information DD1, DD2, . . . , and DDn, respectively, to the audio/video processing device 20a. The delay information DD1, DD2, . . . , and DDn indicate processing times (e.g., hearing aid processing times) corresponding to the first hearing aid 10, the second hearing aid 10, . . . , and the n-th hearing aid 10, respectively. In the audio/video processing device 20a, the delay time setter 103 sets the delay time T103 based on the processing times indicated by the delay information DD1, DD2, . . . , and DDn. For example, the delay time setter 103 may set the delay time T103 to an average value of the processing times corresponding to the n hearing aids 10, 10, . . . , and 10, or a value obtained by multiplying the maximum value of these processing times by a predetermined value (e.g., 0.8). With this configuration, the time difference between sound recognition and image recognition can be uniformly reduced for a plurality of hearing aid users. As a result, uncomfortable viewing and hearing can be reduced for each hearing aid user.

As shown in FIG. 2, the audio/video processing device 20a may provide sounds to a user who does not use a hearing aid as well as one or more hearing aid users. The audio/video processing device 20a includes an audio reproduction circuit 23 which reproduces a sound from the audio signal S100 in addition to the signal processing circuit 21 and the video reproduction circuit 22 of FIG. 1. In this case, the delay time setter 103 may set the delay time T103 to a value obtained by decreasing a delay time obtained based on the delay information DD1 (or the delay information DD1, DD2, . . . , and DDn) (e.g., reducing the delay time by a factor of two). In other words, the delay time T103 may be shorter than the processing time indicated by the delay information. Such a setting allows the time difference between the outputs of the audio reproducer 106 of the hearing aid 10 and the video reproduction circuit 22 to approach the time difference between the outputs of the audio reproduction circuit 23 and the video reproduction circuit 22. As a result, uncomfortable viewing and hearing can be reduced for a hearing aid user while an increase in uncomfortable viewing and hearing can be reduced for a user who does not use a hearing aid (e.g., a healthy user). Thus, an inconvenience to a user who does not use a hearing aid can be reduced or avoided.

Note that the n information transmission circuits 11, 11, . . . , and 11 corresponding to the n hearing aid bodies 12, 12, . . . , and 12 may be replaced with a single information transmission circuit. Specifically, a single information transmission circuit 11 (e.g., a single remote controller) may deal with the n hearing aid bodies 12, 12, . . . , and 12. The audio reproduction circuit 23 may be separated from the signal processing circuit 21 and the video reproduction circuit 22, or integrated with the signal processing circuit 21 and the video reproduction circuit 22 to form the audio/video processing device 20a.

### Second Embodiment

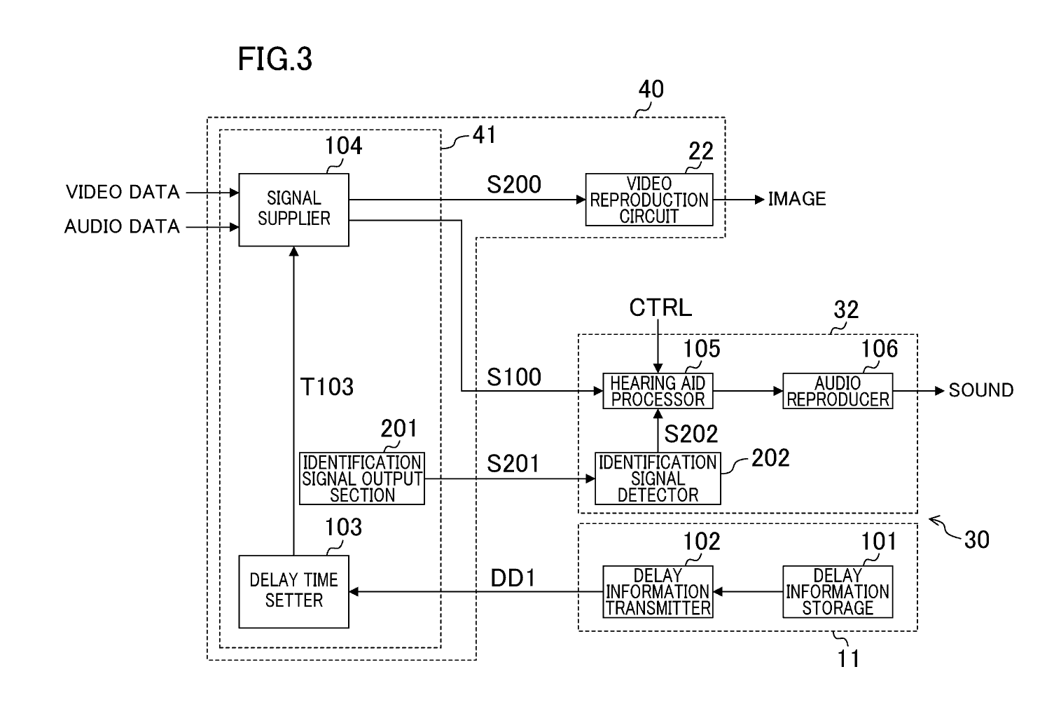

FIG. 3 shows an example configuration of an audio/video reproduction system according to a second embodiment. This system includes a hearing aid 30 including an information transmission circuit 11 and a hearing aid body 32, and an audio/video processing device 40 including a signal processing circuit 41 and a video reproduction circuit 22. The signal processing circuit 41 further includes an identification signal output section 201 in addition to the delay time setter 103 and the signal supplier 104 of FIG. 1. The hearing aid body 32 further includes an identification signal detector 202 in addition to the hearing aid processor 105 and the audio reproducer 106 of FIG. 1. Note that the signal processing circuit 41 may include separate modules: a signal processing module including the signal supplier 104; and a communication module including the delay time setter 103 and the identification signal output section 201.

The identification signal output section 201, when the signal supplier 104 is ready to supply the audio signal S100, outputs an identification signal S201. For example, the identification signal output section 201 may output the identification signal S201 when the audio/video processing device 40 is turned on, or based on an external control (e.g., based on a setting manually provided by the hearing aid user, etc.). The identification signal detector 202, when detecting the identification signal S201, outputs a detection signal S202. For example, if it is assumed that the audio signal S100 and the identification signal S201 are wirelessly transmitted, then when the distance between the hearing aid 30 and the audio/video processing device 40 is long (e.g., a distance at which the hearing aid body 32 cannot normally receive the audio signal S100), the identification signal detector 202 fails to detect the identification signal S201. When the distance between the hearing aid 30 and the audio/video processing device 40 is short (e.g., a distance at which the hearing aid body 32 can normally receive the audio signal S100), the identification signal detector 202 successfully detects the identification signal S201. The hearing aid processor 105 has a plurality of operating modes and performs different hearing aid processes in different operating modes. The hearing aid processor 105 can be switched between the operating modes based on an external control CTRL (e.g., based on a setting manually provided by the hearing aid user, etc.). The hearing aid processor 105, when the detection signal S202 is output, is set to a predetermined operating mode (e.g., an operating mode in which a hearing aid process suitable for a case where a sound is reproduced together with an image is performed).

As described above, when the signal processing circuit 41 is ready to supply the audio signal S100, the hearing aid processor 105 can be automatically set to an appropriate operating mode. For example, when a user who uses the hearing aid 30 turns on the audio/video processing device 40 (e.g., a television), the user can enjoy viewing and hearing with an appropriate volume and quality of sound (e.g., the volume and quality of sound specialized in a television). Moreover, when a hearing aid user approaches the audio/video processing device 40 (a hearing aid user enters a region where the user can view and hear), the hearing aid user may be made aware of the presence of the audio/video processing device 40.

Note that the identification signal detector 202 may be included in the hearing aid body 32 or the information transmission circuit 11. The audio/video processing device 40 of FIG. 3 may deal with the hearing aids 30, 30, . . . , and 30 as shown in FIG. 2, or may further include the audio reproduction circuit 23 of FIG. 2.

### Other Embodiments

In each of the above embodiments, signal transfer (transfer of the audio signal S100, the delay information DD1, etc.) between the hearing aid and the audio/video processing device may be performed by wireless communication or wired communication. For example, in the second embodiment, the identification signal S201 may be transferred to the hearing aid 30 via a cord which connects the audio/video processing device 40 and the hearing aid 30 together.

In the audio/video processing devices, when an audio signal is transmitted to a plurality of hearing aids, a plurality of audio signals having different delay times may be output. With this configuration, a sound having an optimized delay time can be output for each of the hearing aids.

A signal which is input to the signal processing circuits 21 and 41 may be a broadcast signal, such as an analog or digital broadcast signal, a reproduced signal read from a storage medium, such as a video-CD, a DVD, a Blu-ray disk, or a videotape, or a signal captured by a camcorder. The signal processing circuits 21 and 41 may receive audio data and video data in a time-division manner or in a multiplexed manner.

As described above, in the above audio/video reproduction systems, the time difference between sound recognition and image recognition of a hearing aid user can be reduced. Therefore, the audio/video reproduction systems are useful for a hearing aid process for aiding the auditory function, etc.

Note that the above embodiments are merely exemplary in nature and are in no way intended to limit the scope of the present disclosure, its application, or uses.

What is claimed is:

1. A system for reproducing a sound and an image, comprising:
a hearing aid; and
an audio/video processing device including a signal processing circuit and a video reproduction circuit,
wherein
the signal processing circuit supplies an audio signal to the hearing aid, and delays a video signal from the audio signal by a delay time of the hearing aid and supplies the delayed video signal to the video reproduction circuit,
the hearing aid performs a hearing aid process on the audio signal supplied from the signal processing circuit to reproduce a sound, and
the video reproduction circuit reproduces an image from the video signal supplied from the signal processing circuit.

2. The system of claim 1, wherein
the hearing aid transmits delay information indicating a hearing aid processing time required for the hearing aid process, and
the signal processing circuit sets the delay time based on the delay information.

3. The system of claim 1, wherein
the hearing aid transmits delay information indicating the sum of a hearing aid processing time required for the hearing aid process and a transfer processing time required for transfer of the audio signal from the audio/video processing device to the hearing aid, and
the signal processing circuit sets the delay time based on the delay information.

4. The system of claim 1, wherein
the signal processing circuit outputs an identification signal when the signal processing circuit is ready to supply the audio signal, and
the hearing aid, when detecting the identification signal, performs a predetermined hearing aid process on the audio signal.

5. A system for reproducing a sound and an image, comprising:
a plurality of hearing aids; and
an audio/video processing device including a signal processing circuit and a video reproduction circuit,
wherein
the signal processing circuit supplies an audio signal to each of the plurality of hearing aids, and delays a video signal from the audio signal by a delay time obtained based on processing times of the plurality of hearing aids and supplies the delayed video signal to the video reproduction circuit,
each of the plurality of hearing aids performs a hearing aid process on the audio signal supplied from the signal processing circuit to reproduce a sound, and
the video reproduction circuit reproduces an image from the video signal supplied from the signal processing circuit.

6. The system of claim 1, wherein
the delay time is changed by an external control.

7. A hearing aid for processing an audio signal supplied from an audio/video processing device, comprising:
an information transmission circuit including a delay information transmitter configured to transmit delay information indicating a processing time of the hearing aid to the audio/video processing device; and
a hearing aid body including a hearing aid processor configured to perform a hearing aid process on the audio signal supplied from the audio/video processing device and an audio reproducer configured to reproduce a sound from the audio signal processed by the hearing aid processor.

8. The hearing aid of claim 7, wherein
the processing time includes a hearing aid processing time required for the hearing aid process.

9. The hearing aid of claim 7, wherein
the processing time includes the sum of a hearing aid processing time required for the hearing aid process and a transfer processing time required for transfer of the audio signal from the audio/video processing device to the hearing aid body.

10. The hearing aid of claim 7, wherein
one of the hearing aid body and the information transmission circuit further includes an identification signal detector configured to detect an identification signal indicating readiness to supply the audio signal, and
the hearing aid processor performs a predetermined hearing aid process on the audio signal in response to the detection performed by the identification signal detector.

11. The hearing aid of claim 7, wherein
the delay information transmitter changes the processing time indicated by the delay information based on an external control before transmitting the delay information to the audio/video processing device.

12. The hearing aid of claim 7, wherein
the information transmission circuit is separated from the hearing aid body.

13. A device for supplying an audio signal to a hearing aid and reproducing an image, including:
a signal processing circuit; and
a video reproduction circuit,
wherein
the signal processing circuit supplies an audio signal to the hearing aid, and delays a video signal from the audio signal by a delay time of the hearing aid and supplies the delayed video signal to the video reproduction circuit,
the video reproduction circuit reproduces an image from the video signal supplied from the signal processing circuit.

14. The audio/video processing device of claim 13, wherein
the hearing aid transmits delay information indicating a hearing aid processing time required for the hearing aid process, and
the signal processing circuit sets the delay time based on the delay information.

15. The audio/video processing device of claim 13, wherein
the hearing aid transmits delay information indicating the sum of a hearing aid processing time required for the hearing aid process and a transfer processing time required for transfer of the audio signal from the signal processing circuit to the hearing aid, and
the signal processing circuit sets the delay time based on the delay information.

16. The audio/video processing device of claim 13, wherein
the signal processing circuit outputs an identification signal when the signal processing circuit is ready to supply the audio signal.

17. The audio/video processing device of claim 13, wherein
the signal processing circuit sets the delay time based on processing times of a plurality of hearing aids, and supplies the audio signal to the plurality of hearing aids, and delays the video signal from the audio signal by the set delay time and supplies the delayed video signal to the video reproduction circuit.

18. The audio/video processing device of claim 13, wherein
the signal processing circuit changes the delay time by an external control.
